(19) United States
(12) Patent Application Publication
(10) Pub. No.: US 2012/0123068 A1
(43) Pub. Date: May 17, 2012

(54) NOVEL COMBINATIONS OF SILANE ELECTRON DONORS FOR USE IN CATALYST COMPOSITIONS

(75) Inventors: Joseph L. Thorman, League City, TX (US); Kenneth P. Blackmon, Houston, TX (US)

(73) Assignee: FINA TECHNOLOGY, INC., Houston, TX (US)

(21) Appl. No.: 11/846,676

(22) Filed: Aug. 29, 2007

Related U.S. Application Data
(62) Division of application No. 11/124,032, filed on May 6, 2005, now abandoned.

(51) Int. Cl. C08F 4/76

(52) U.S. Cl. 526/126

(57) ABSTRACT

Disclosed is a process for preparing an olefinic polymer comprising contacting at least one olefinic C3+ monomer and a catalyst composition comprising a Ziegler-Natta catalyst, dicyclopentyl dimethoxysilane as a first electron donor, and a second electron donor selected from the group consisting of methyl trimethoxysilane, methyl triethoxysilane, dimethyl dimethoxysilane, and mixtures thereof, under reaction conditions suitable to form an olefinic polymer. The polymer prepared using this method may exhibit significantly broadened molecular weight distribution than that achieved using any of the silane compounds alone, and may also exhibit desirable melt flow characteristics and xylene solubles levels.

### BACKGROUND OF THE INVENTION

1. Technical Field

This invention relates generally to olefinic polymers, and more particularly to catalyst systems for preparing such polymers.

2. Background of the Art

A number of catalyst systems exist for the preparation of olefinic polymers.

Many of these systems are solid systems comprising magnesium, titanium, halogen and an electron donor. Such systems find particular use in polymerization of alpha-olefins having at least 2 carbon atoms, and produce a highly stereoregular polymer in high yield.

Generally such olefinic polymers display a broad range of molecular weight distributions (MWD) and have excellent mechanical properties. However, improvements in MWD continue to be sought for some applications requiring better processability and resins having better mechanical properties.

One way to improve resin properties is to broaden molecular weight distribution. This can be accomplished by preparing olefins having different molecular weights in a plurality of polymerization reactors and then blending them. This approach is obviously time-consuming and adds to the complexity and expense of polymer production processes.

An alternative way to accomplish the same goal is to use a polymerization catalyst system having at least two specific external electron donors. This allows production of a polymer having improved properties, due to broadened molecular weight distribution, in a single process step. Combinations of electron donors identified thus far show some improvements, but attainable MWD's using commercially known combinations have remained disappointing. Accordingly, it is desired in the art to identify a process for preparing olefinic polymers that results in products with superior physical properties and MWDs.

### SUMMARY OF THE INVENTION

In one aspect, the invention is a process for preparing an olefinic polymer including contacting at least one olefinic C3+ monomer and a catalyst composition including a Ziegler-Natta catalyst, dicyclopentyl dimethoxysilane as a first electron donor, and a second electron donor selected from the group consisting of methyl trimethoxysilane, methyl triethoxysilane, dimethyl dimethoxysilane, and mixtures thereof. These components are combined under reaction conditions suitable to form an olefinic polymer wherein the polymer produced has a molecular weight distribution that is broader than that of a polymer produced under the same conditions using any of the electron donors alone.

In another aspect, the invention is an olefinic polymer prepared by a process including contacting at least one olefinic C3+ monomer and a catalyst composition including a Ziegler-Natta catalyst, dicyclopentyl dimethoxysilane as a first electron donor, and a second electron donor selected from the group consisting of methyl trimethoxysilane, methyl triethoxysilane, dimethyl dimethoxysilane, and mixtures thereof. These components are combined under reaction conditions suitable to form an olefinic polymer wherein the olefinic polymer produced has a molecular weight distribution that is broader than that of a polymer produced under the same conditions using any of the electron donors alone.

In still another aspect, the invention is a process for preparing an olefinic polymer including contacting one or more monomers selected from the group consisting of propylene, ethylene, and combinations thereof, and a catalyst composition including a Ziegler-Natta catalyst containing titanium, magnesium, a cocatalyst or a combination thereof; a dicyclopentyl dimethoxysilane as a first electron donor; and a second electron donor selected from the group consisting of methyl trimethoxysilane, methyl triethoxysilane, dimethyl dimethoxysilane, and mixtures thereof. In this aspect, the first and second electron donors are present in a ratio of from about 1:5 to about 5:1. The components are combined under reaction conditions suitable to form an olefinic polymer wherein the olefinic polymer produced has a molecular weight distribution that is broader than that of a polymer produced under the same conditions using any of the electron donors alone.

Another aspect of the invention is an article of manufacture comprising a film, an injection molded article, or a blow molded article including an olefinic polymer prepared by a process including contacting at least one olefinic C3+ monomer and a catalyst composition including a Ziegler-Natta catalyst, dicyclopentyl dimethoxysilane as a first electron donor, and a second electron donor selected from the group consisting of methyl trimethoxysilane, methyl triethoxysilane, dimethyl dimethoxysilane, and mixtures thereof. These components are combined under reaction conditions suitable to form an olefinic polymer wherein the olefinic polymer produced has a molecular weight distribution that is broader than that of a polymer produced under the same conditions using any of the electron donors alone.

### DETAILED DESCRIPTION OF THE INVENTION

In this invention one or more olefin monomers, at least one of the monomers having at least 3 carbons (C3+ monomer), may be polymerized by subjecting them, under suitable reaction conditions, to the effects of a polymerization catalyst system. As used herein, the term “polymerization” denotes homopolymerization and/or copolymerization, and the term “polymer” refers to homopolymers, copolymers, and any and all multi-mer polymers such as terpolymers.

This catalyst system desirably includes a Ziegler-Natta catalyst component, which in some embodiments may be a solid titanium catalyst component comprising magnesium, titanium, halogen and an electron donor. This solid titanium catalyst component may be prepared generally by contacting a magnesium compound, a titanium compound, and an electron donor under reaction conditions suitable for forming a catalyst. Examples of the titanium compound used in the preparation of the solid titanium catalyst component are tetravalent titanium compounds of the following formula:

Ti(OR)_{g}(X)_{4-g}

wherein R is a hydrocarbon group, X is a halogen atom, and g is from 0 to 4.

More specific examples include titanium tetrahalides such as TiCl₄, TiBr₄, and TiI₄: alkoxy titanium trihalides such as Ti(OCH₃)Cl₃, Ti(OC₂H₅)Cl₃, Ti(O n-C₄H₉)Cl₃, Ti(OC₂H₅)Br₃, and Ti(O iso-C₄H₉)Br; dialkoxytitanium dihalides such as Ti(OCH₃)₂Cl₂, Ti(OC₂H₅)₂Cl₂, Ti(O n-C₄H₉)₂Cl₂ and Ti(OC₂H₅)₂Br₂; trialkoxytitanium monohalides such as Ti(OCH₃)₃Cl, Ti(OC₂H₅)₃Cl, Ti(O n-C₄H₉)₃C1 and Ti(OC₂H₅)₃Br; and tetraalkoxy titaniums such as Ti(OCH₃)₄. Ti(OC₂H₅)₄ and Ti(O n-C₄H₉)₄.

Of these, the halogen-containing titanium compounds, particularly titanium tetrahalides, are desirable in some embodiments. Especially preferred in other embodiments is titanium tetrachloride. The titanium compounds may be used singly or in combination with each other. The titanium compound may be diluted with a hydrocarbon compound or a halogenated hydrocarbon compound.

The magnesium compound to be used in the preparation of the solid titanium catalyst component may include dimethyl magnesium, diethyl magnesium, dipropyl magnesium, dibutyl magnesium, diamyl magnesium, dihexyl magnesium, didecyl magnesium, magnesium ethyl chloride, magnesium propyl chloride, magnesium butyl chloride, magnesium hexyl chloride, magnesium amyl chloride, butyl ethoxy magnesium, ethyl butyl magnesium and butyl magnesium halides. These magnesium compounds may be used singly or in combination, or they may form complexes with the organoaluminum compounds to be described. These magnesium compounds may be liquid or solid.

Specific examples of the magnesium compounds include magnesium halides such as magnesium chloride, magnesium bromide, magnesium iodide and magnesium fluoride; alkoxy magnesium halides such as magnesium methoxy chloride, magnesium ethoxy chloride, magnesium isopropoxy chloride, magnesium phenoxy chloride and magnesium methylphenoxy chloride; alkoxy magnesiums such as ethoxy magnesium, isopropoxy magnesium, butoxy magnesium, n-octoxy magnesium and 2-ethylhexoxy magnesium; aryloxy magnesiums such as phenoxy magnesium and dimethylphenoxy magnesium; and magnesium carboxylates such as magnesium laurate and magnesium stearate.

In preparing the Ziegler-Natta component of the inventive catalyst compositions, it is desirable to use an electron donor. First, an internal electron donor may be used in the formation reaction of the catalyst. The internal electron-donor compounds suitable for preparing conventional Ziegler-Natta catalyst components include ethers, ketones, lactones, electron donors compounds with N, P and/or S atoms and specific classes of esters.

The second use for an electron donor in a catalyst system is as an external electron donor and stereoregulator in the polymerization reaction. The same compound may be used in both instances, although typically they are different. A description of the two types of electron donors is provided in U.S. Pat. No. 4,535,068, the disclosure of which is hereby incorporated by reference. Electron donors are further described in U.S. Pat. No. 5,652,303, and U.S. Patent Publication No. 20030060580, the disclosures of which are incorporated herein by reference.

Examples of electron donors useful with the invention may include, but are not limited to esters of organic or inorganic oxides, ethers, acid amides and acid anhydrides. More specific examples include; inorganic acid esters such as ethyl silicate and butyl silicate; acid halides having 1 to 15 carbon atoms such as acetyl chloride, benzoyl chloride, toluoyl chloride, anisoyl chloride and phthaloyl dichloride; ethers having 2 to 20 carbon toms such as methyl ether, ethyl ether, isopropyl ether, butyl ether, amyl ether, tetrahydrofuran, anisole and diphenyl ether; acid amides such as acetamide, benzamide and toluamide; acid anhydrides such as benzoic anhydride and phthalic anhydride; amines such as methylamine, ethylamine, triethylamine, tributylamine, piperidine, tribenzylamine, aniline, pyridine, picoline and tetramethylethylenediamine; and nitriles such as acetonitrile, benzonitrile and trinitrile.

The invention includes use of a particularly effective combination of external electron donors. One of these external electron donors is dicyclopentyldimethoxysilane (CPDS). At least one additional electron donor is also required. This second electron donor is selected from the group consisting of methyltrimethoxysilane (MTMS), methyltriethoxysilane (MTES), dimethyldimethoxysilane (DMDS), and mixtures thereof. It has surprisingly been found that the combination of these particular materials with the Ziegler-Natta catalyst and the selected olefinic monomers results in a polymer having a synergistically and significantly broadened molecular weight distribution as compared with polymers prepared with only one of these electron donors.

The total weight amount of the electron donors, in one embodiment, may vary from about 0.5 to about 500 ppm, based upon the weight of the monomer. In another embodiment the total amount may vary from about 0.5 to about 200 ppm, and in another non-limiting embodiment, may vary from about 0.5 to about 50 ppm. The molar ratio of the two donors is, in some desirable embodiments, from about 5 moles of CPDS to about 1 mole of the second electron donor. In other desirable embodiments it may be from about 1 mole of CPDS to about 5 moles of the second electron donor.

In still another non-limiting embodiment, the molar ratio of the total silane donors to the Ziegler-Natta compound may vary from about 0.25 to about 500; in yet another non-limiting embodiment from about 0.5 to about 100; and in still another non-limiting embodiment from about 0.5 to about 20.

The invention may include the use of a cocatalyst. Typically the cocatalyst is an organoaluminum compound. Desirably the co-catalyst is an aluminum alkyl having the formula AIR₃, where R is an alkyl having 1 to 8 carbon atoms, with R being the same or different. Examples of suitable aluminum alkyls are trimethyl aluminum (TMA), triethyl aluminum (TEAI) and triisobutyl aluminum (TiBAI).

Olefinic polymers, including but not limited to polypropylene, random propylene-ethylene copolymers, and the like, may be produced by a variety of polymerization methods, including slurry polymerization in the presence of a solvent, e.g., hexane, such as in a loop or CSTR-type reactor; bulk polymerization in which the monomer being polymerized also serves as its own diluent, which is typically carried out in a loop-type reactor; gas phase polymerization, which is typically carried out in a fluidized bed reactor under lower pressures than bulk polymerization; and so forth. In a typical bulk process for preparing polypropylene, for example, one or more loop reactors operating generally from about 50 to about 100° C. (and in another non-limiting embodiment from about 60 to about 80° C.), with pressures of from about 300 to about 700 psi (2.1 to 4.8 MPa) may be employed. In other non-limiting embodiments pressures may vary from about 450 to about 650 psi (3.1 to 4.5 MPa). The various catalytic components, i.e., Ziegler-Natta catalyst, any selected cocatalyst CPDS and selected second electron donor or donors, may be introduced into the reactor, along with a molecular weight controlling agent if desired. A frequently-selected molecular weight controlling agent is hydrogen. The resulting polypropylene fluff or powder is continuously removed from the reactor. The fluff may then be subjected to extrusion to produce pellets.

For bulk polymerization, reactor temperatures are desirably maintained, in one embodiment, from about 50 to about 100° C., and in other embodiments desirably from about 60 to about 80° C. Hydrogen concentrations may vary, but in one embodiment are maintained at from about 0.02 mol % to about 1.1 mol %.

In another non-limiting embodiment the hydrogen is maintained from about 0.04 mol % to about 0.5 mol %, based on monomer. The hydrogen concentration may be varied, as is known to those skilled in the art, to adjust the desired final resin melt flow characteristics.

The resulting polymers produced using the novel catalyst system described herein are, in one embodiment, those having a melt flow after polymerization of at least 0.5 dg/min or greater, as measured according to ASTM D1238-95. Those skilled in the art will be aware that typical melt flow rates useful for preparation of biaxially-oriented polypropylene (BOPP) films are from about 1 to about 100 dg/min, with from about 1 to about 16 dg/min being frequently employed commercially. At these melt flow rates polymers produced by the process of the invention may, in some embodiments, still retain desirably low xylene solubles contents. Thus, the polymers of this invention are expected to be particularly suitable for preparing films as well as for extensive use in injection molding applications. The polymers produced may also be characterized in some embodiments as having low xylene solubles contents of not more than about 6 weight percent, and in other embodiments from about 1 to about 5 weight percent.

Additionally, the polypropylene homopolymers or copolymers produced using the inventive catalyst system may have a meso pentad level of from about 93 to about 99 weight percent, as measured via ¹³C NMR on the insoluble (i.e., crystalline) fraction. The polydisperity (Mw/Mn), i.e., the molecular weight distribution (MWD), of the polymer, as measured via Size Exclusion Chromatography, may in some embodiments range from about 5 to about 14 polydisperity units, and in other, non-limiting embodiments, from about 7 to about 11 polydisperity units.

As used herein, the terms “propylene polymer” or “polypropylene”, unless specified otherwise, shall mean propylene homopolymers and those polymers composed primarily of propylene and limited amounts of other comonomers, such as ethylene. The copolymers of the invention may have from about 0.1 to about 9 weight percent comonomers. In another embodiment, the copolymers have from about 0.5 to about 8 percent comonomers. In still another embodiment, the copolymers may have from about 2 to about 8 percent comonomer content. The catalyst components of this invention provide another way of adjusting the microtacticity of the polypropylene and thus improving the properties of the final product, particularly where such is destined for use in preparing films. The term “terpolymers” shall mean polymers having at least three monomers, at least one of which is propylene, wherein the combined weight percent of monomers other than propylene may range from about 0.1 to about 20 percent.

The following examples serve to illustrate the invention, and are not intended to limit its scope in any way. Those skilled in the art will understand that alterations, changes and modifications may be made to the process or products, including but not limited to selection of Ziegler-Natta catalyst(s), monomer(s), proportions, reaction conditions, reaction equipment, production protocol, and the like, including selections generally but not explicitly described or defined herein, without departing from the scope of the invention as claimed.

The olefinc polymer and copolymers prepared using the invention may be useful in many different applications. For example, these polymers prepared using the invention may be useful in extrusion applications where their broad molecular weight distributions may allow for easier processing. Heat seal film is one such application. They may also be useful in blow-molding and injection molding applications.

### EXAMPLES

### Example 1

A number of exemplary and comparative polymerizations are carried out under the polymerization conditions shown in Table 1. Each polymerization uses as a commercially available catalyst system including Toho THC A (a conventional 4th-generation titanium containing propylene polymerization catalyst available from Toho Catalyst Co., Ltd.), and one or two electron donors as shown in Table 2. Table 2 shows the molecular weight distribution and a number of other characteristics (e.g., bulk density (BD), melt flow, xylene solubles) of the homopolypropylene polymers prepared. Throughout the polymerizations the Al/Si ratio is 50, and about 0.43 mol % H₂ concentration is employed. The abbreviated names of the compounds used as the electron donors are as shown in Table 3.

TABLE 1

| REAGENT: | | |
|---|---|---|
| ZN Catalyst | 10 | mg |
| TEAI | 1.0 | mmol |
| Total External Donor | 0.02 | mmol |
| Hydrogen | 0.41-0.43 | mol % |
| Propylene | 1.4 | L (0.74 kg) |
| CONDITIONS: | | |
| Temperature | 70° C. | |
| Time | 1 | hour |

TABLE 2

| | | | | | Mn | Mw | Mz | |
|---|---|---|---|---|---|---|---|---|
| | Activity | BD | MF | | K | K | KK | |
| DONOR | (kg/g/h) | (g/cm3) | (dg/min) | XS | Daltons | Daltons | Daltons | MWD |
| CPDS* | 46.2 | 0.48 | 7.7 | 1.2 | — | — | — | 8.8 |
| DIDS* | 46.0 | 0.49 | 7.3 | 1.5 | 39.0 | 382 | 2.22 | 9.8 |
| DSBDMS* | 44.0 | 0.48 | 13.0 | 2.2 | 34.3 | 327 | 1.94 | 9.5 |
| VTES* | 40.8 | 0.46 | 28.6 | 3.4 | 35.3 | 215 | 0.92 | 6.1 |
| DMDS* | 44.3 | 0.40 | 65.3 | 11.1 | 25.7 | 172 | 0.87 | 6.7 |
| MTMS* | 42.3 | 0.38 | 70.0 | 9.9 | 27.0 | 177 | 0.89 | 6.6 |
| MTES* | 38.5 | 0.42 | 155.9 | 9.8 | 22.6 | 123 | 5.28 | 5.4 |
| 4:1 MTMS/- | 40.1 | 0.49 | 7.4 | 1.0 | 37.6 | 353 | 2.13 | 10.5 |
| CPDS | | | | | | | | |
| 1:1 MTMS/- | 44.9 | 0.49 | 7.1 | 1.4 | 37.6 | 394 | 2.13 | 10.5 |
| CPDS | | | | | | | | |
| 1:1 MTMS/- | 42.9 | 0.49 | 14.9 | 1.7 | 34.0 | 291 | 1.56 | 8.5 |
| DSBDMS* | | | | | | | | |
| 1:1 DMDS/- | 44.4 | 0.48 | 8.8 | 1.2 | 37.0 | 345 | 1.68 | 9.3 |
| CPDS | | | | | | | | |
| 1:1 VTES/- | 44.0 | 0.47 | 11.0 | 2.1 | 37.0 | 331 | 1.63 | 9.0 |
| CPDS* | | | | | | | | |
| 1:1 MTES/- | 45.5 | 0.49 | 6.4 | 1.6 | 38.7 | 376 | 1.86 | 9.7 |
| CPDS | | | | | | | | |
| 1:1 MTES/- | 44.0 | 0.48 | 14.1 | 1.3 | 33.7 | 295 | 1.51 | 8.7 |
| DSBDMS* | | | | | | | | |
| 1:1 MTMS/- | 48.0 | 0.48 | 13.9 | 2.1 | 29.9 | 289 | 1.51 | 9.7 |
| DIDS* | | | | | | | | |
| 1:1 MTES/- | 47.2 | 0.49 | 14.5 | 1.2 | 35.1 | 344 | 1.90 | 9.8 |
| DIDS* | | | | | | | | |

*indicates not an example of the invention; included for comparative purposes.
— indicates data not taken or recorded.

1. A process for preparing an olefinic polymer comprising contacting at least one olefinic C3+ monomer and a catalyst composition comprising a Ziegler-Natta catalyst, dicyclopentyl dimethoxysilane as a first electron donor, and a second electron donor selected from the group consisting of methyl trimethoxysilane, methyl triethoxysilane, dimethyl dimethoxysilane, and mixtures thereof, under reaction conditions suitable to form an olefinic polymer wherein the polymer produced has a molecular weight distribution that is broader than that of a polymer produced under the same conditions using any of the electron donors alone.

2. The process of claim 1 wherein the olefinic C3+ monomer is selected from the group consisting of propylene, ethylene and combinations thereof.

3. The process of claim 1 wherein the Ziegler-Natta catalyst is based on titanium, magnesium, halogen, cocatalyst, or a combination thereof.

4. The process of claim 1 wherein the first and second electron donors are, in total, present in an amount of from about 0.5 to about 1000 ppm, based on weight of monomer.

5. The process of claim 4 wherein the first and second electron donors are, in total, present in an amount of from about 0.5 to about 200 ppm, based on weight of monomer.

6. The process of claim 1, wherein the molar ratio of the first electron donor to the second donor is from about 1:5 to about 5:1.

7. The process of claim 1 further comprising a cocatalyst.

8. The process of claim 7 wherein the cocatalyst is selected from the group consisting of TEAL, TiBAl, and mixtures thereof.

9. The process of claim 1 wherein the reaction conditions include a temperature from about 50 to about 100° C. and a pressure from about 300 to about 700 psi (about 2.1 to about 4.8 MPa).

10. The process of claim 1 wherein the olefinic polymer is selected from the group consisting of polypropylene, and random propylene-ethylene copolymers.

11. The process of claim 1 wherein the olefinic polymer has molecular weight distribution of from about 5 to about 14.

12.-19. (canceled)

20. A process for preparing an olefinic polymer comprising contacting one or more monomers selected from the group consisting of propylene, ethylene, and combinations thereof, and a catalyst composition comprising
a Ziegler-Natta catalyst containing titanium, magnesium, halogen, a cocatalyst or a combination thereof;
dicyclopentyl dimethoxysilane as a first electron donor; and
a second electron donor selected from the group consisting of methyl trimethoxysilane, methyl triethoxysilane, dimethyl dimethoxysilane, and mixtures thereof;
wherein the first and second electron donors are present in a molar ratio of from about 1:5 to about 5:1 under reaction conditions suitable to form an olefinic polymer wherein the olefinic polymer produced has a molecular weight distribution that is broader than that of a polymer produced under the same conditions using any of the electron donors alone.

21. (canceled)
